(19) United States
(12) Patent Application Publication
(10) Pub. No.: US 2004/0083486 A1
(43) Pub. Date: Apr. 29, 2004

(54) Method and apparatus for controlling the display of program guide

(76) Inventor: Mi-Ju Park, Seoul (KR)

Correspondence Address: Christian C. Michel, Roylance, Abrams, Berdo & Goodman, L.L.P., Suite 600, 1300 19th Street, N.W., Washington, DC, 20036, US

(21) Appl. No.: 10/639,533

(22) Filed: Aug. 13, 2003

(30) Foreign Application Priority Data
Oct. 28, 2002 (KR) 2002-65840

(51) Int. Cl. G06F 13/00; H04N 5/445; G06F 3/00; H04N 7/16

(52) U.S. Cl. 725/30; 725/39; 725/25

(57) ABSTRACT

A method and apparatus for controlling the display of a program guide in a digital television receiver are provided. The program guide display control method includes displaying a lock setting menu and requesting a password if a lock mode command for a channel is issued; locking a corresponding channel if a password input by a user is identical to a predetermined password; and skipping program information of the locked channel and collecting program information of non-locked channels for display on a screen if a program guide signal for all channels is received.

This application claims priority from Korean Patent Application No. 2002-65840, filed on Oct. 28, 2002, in the Korean Intellectual Property Office, the disclosure of which is incorporated herein by reference in its entirety.

### BACKGROUND

1. Field of the Invention

The present invention relates to a receiving system of a digital television that displays a program guide, and more particularly to a method and apparatus for controlling the display of a program guide in a digital television receiver.

2. Description of the Related Art

Generally, a digital television receiver receives digital broadcast signals in a packet-based bit-stream format, extracts a broadcast signal selected from the received broadcast signals, and decodes the extracted broadcast signal, according to the Motion Picture Expert Group (MPEG) protocol, for display on a screen.

Such a digital television receiver mixes the bit-stream format of the digital broadcast signal and an intermediate frequency (IF) signal, and tunes to a channel selected by a user.

Meanwhile, a digital broadcast signal received by a digital television through a fixed channel is restored to a transmission stream through a process involving signal conversion, demodulation, and error correction, etc. The transmission stream includes program service data such as television broadcast information, data broadcast information, Electronic Programming Guide (EPG) data, etc.

EPG data is transmitted in a packet format, and includes a menu for broadcast programs, which is displayed on a screen. Accordingly, an EPG picture menu facilitates identification of desired programs by allowing the user to view the broadcast time, the program distributor (broadcasting station), the broadcast length, and the program title of programs.

However, such a digital television receiver has many more channel numbers than an analog television receiver. For example, the United States provides services for digital television, supporting nearly one hundred or more channels. Accordingly, a problem exists in that as the number of channels becomes greater, the time required to display the program information of the channels becomes longer, increasing the difficulty of searching for a desired program among the plurality of channels specified in the program guide.

### SUMMARY OF THE INVENTION

The present invention provides a method and apparatus for controlling the display of a program guide, which prevents the display of program information for channels that are locked by a user in a digital television receiver.

According to an aspect of the present invention, there is provided a method of controlling the display of a program guide, comprising the steps of displaying a lock setting menu and requesting a password, if a lock mode command for a channel is issued; locking a corresponding channel, if a password input by a user is identical to a predetermined password; and skipping program information of the locked channel and collecting program information of non-locked channels for display on a screen, if a program guide signal for all channels is received.

According to another aspect of the present invention, there is provided an apparatus which controls the display of a program guide, in a digital television receiver. The apparatus comprises a signal processor which extracts program guide information included in a broadcast signal; and a controller which locks a corresponding channel if a lock mode command is issued, skips program information of the locked channel among the program guide information extracted by the signal processor, and collects program information for non-locked channels, to create a program guide.

### BRIEF DESCRIPTION OF THE DRAWINGS

The above and other features and advantages of the present invention will become more apparent with reference to the attached drawing figures and detailed description of exemplary embodiments, in which:

FIG. 1 is a block diagram of a digital television receiver adopting a program guide display control method according to an embodiment of the present invention;

FIGS. 2A and 2B are a flow chart illustrating the program guide display control method according to an embodiment of the present invention; and

FIG. 3 shows an example of a program guide displayed on a screen, according to an embodiment of the present invention.

### DETAILED DESCRIPTION OF THE INVENTION

Hereinafter, embodiments of the present invention will be described in detail with reference to the appended drawings.

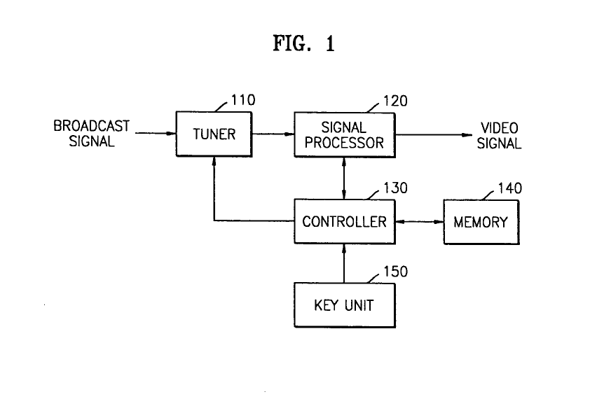

FIG. 1 is a block diagram of a digital television receiver adopting a program guide display control method according to the present invention.

The digital television receiver shown in FIG. 1 includes a tuner 110, a signal processor 120, a controller 130, a memory 140, and a key unit 150.

Referring to FIG. 1, the tuner 120 tunes to a broadcast channel selected by a user, using a tuning control signal supplied from the controller 130. The channel is selected among broadcast signals received through a digital signal receiving antenna (not shown).

The signal processor 120 converts the tuned broadcast signal into an intermediate frequency (IF) signal, restores the converted signal into a transmission stream through demodulation and error correction, and decodes the restored stream, producing the original video signal.

The signal processor 120 also extracts additional information included in the stream. Specifically, packet data representing a program guide is extracted in response to an Electronic Programming Guide (EPG) request signal provided by the controller 130. Then, the signal processor 120 converts the extracted packet data into an intermediate frequency (IF) signal, restores the IF signal into EPG data through demodulation and error correction, and provides the restored EPG data to the controller 130. The program guide packet data includes program information, and the channel and time information corresponding thereto.

The key unit 150 includes lock mode selection keys for setting a lock mode for each channel and a lock mode for each program.

The controller 130 temporarily stores the EPG data extracted from the signal processor 120 in the memory 140. When certain information is required by the key unit 150, the controller 130 extracts the corresponding EPG data from the memory 140, collects the EPG data corresponding to each channel, and displays the collected data as a program guide on a screen. Also, if a lock mode command for a channel is issued through a specific key of the key unit 150, the controller 130 outputs on the screen a picture representing the channel's lock setting menu and an on screen display (OSD) picture requesting a password. If the password input by the user is identical to a predetermined password, the controller 130 sets a lock for the channel and stores the locked channel information in the memory 140. Then, if a program guide signal is received, the controller 130 skips program information for the locked channel, and extracts and displays only program information for non-locked channels.

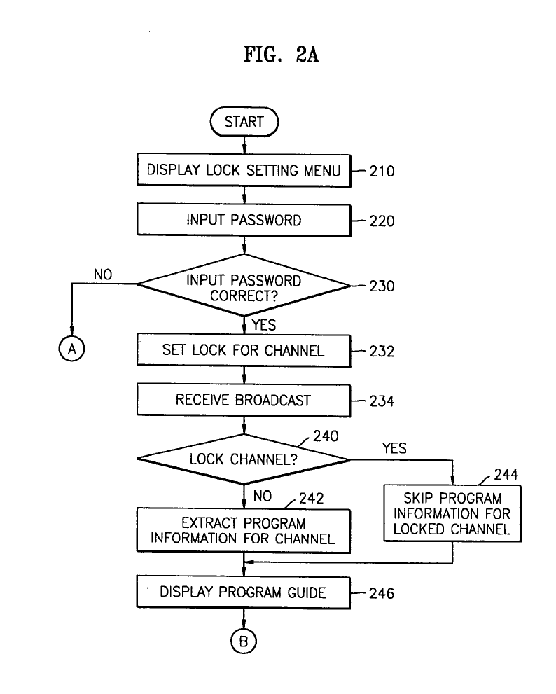

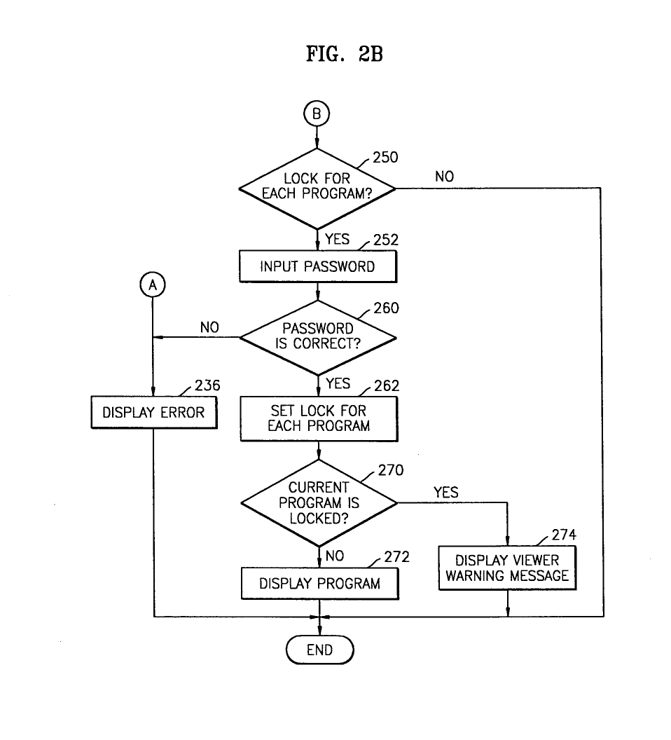

FIGS. 2A and 2B are a flow chart illustrating the program guide display control method according to an embodiment of the present invention.

First, if a lock mode command for a channel is issued, a lock setting menu is displayed on the screen, for setting a lock on the corresponding channel (step 210). The lock setting menu is generally provided by manufacturers as an OSD picture, such as a child lock.

Successively, if an OSD picture requesting a user password is output, a user inputs a password at step 220.

Then, once a user has completed input of a password, it is determined whether the input password is identical to a predetermined password at step 230. If the passwords are the same, a lock for the respective channel is set at step 232. On the other hand, if the passwords are not the same, an error message is displayed on the screen at step 236. The following description will refer to a scenario which assumes that channel 11, channel 15, and channel 28 are unlocked through desired key manipulation of the lock setting menu displayed on the screen, and channels 12 through 14 and channels 16 through 27 are locked.

If a broadcast signal, including EPG information, is received in a stream format at step 234, a check is made for any locked channels at the time of extracting the EPG information from the broadcast stream at step 240. If any locked channels are detected, program information corresponding to the locked channels is skipped at step 244. Only program information corresponding to the unlocked channels is extracted at step 242.

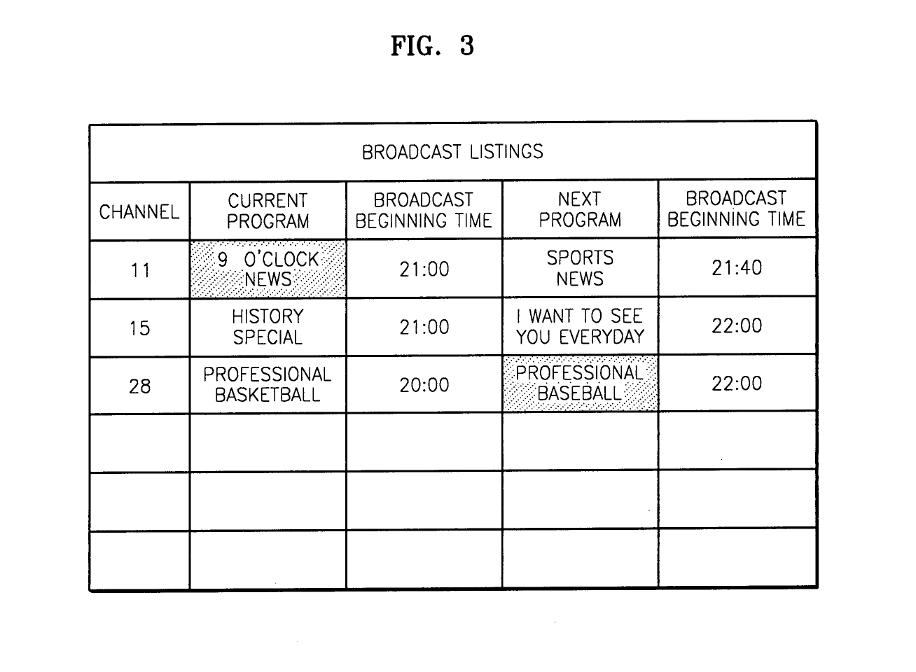

The program information of unlocked channels is successively displayed in a program guide on the screen at step 242. For example, referring to the broadcast listing of FIG. 3, only program guide information for channel 11, channel 15, and channel 28 are displayed, excluding channels 12 through 14 and channels 16 through 27.Then, while the program guide is displayed on the screen, it is determined whether a lock mode command has been issued for each program at step 250.

If an OSD picture requesting a user password is output, a user must input a password at step 252.

If the password input by the user is complete, it is determined whether the input password is identical to a predetermined password at step 260. If the passwords are the same, a lock for the corresponding program is set at step 260. On the other hand, if the passwords are not the same, an error message is displayed on the screen at step 236. In the example shown in FIG. 3, the program “9o'clock news” of channel 11 and the program “professional baseball” of channel 28 are designated through a desired key manipulation.

Then, at the beginning time of broadcast, it is determined whether the program desired by the user is locked at step 270. If the program is locked, a viewer warning (restriction) message is output, indicating that the corresponding program of the channel cannot be viewed at step 274. On the other hand, if the program is not locked, the corresponding program of the channel is displayed at step 272. Password input is requested to release the lock for each program. Also, any time-elapsed programs are automatically unlocked.

As described above, according to the present invention, it is possible to reduce the time required for displaying program information on a screen, by setting a lock for each channel that the user does not wish to view. Also, it is possible to prevent a different user from viewing certain programs, by setting a lock for those programs.

The present invention may be embodied in a general purpose digital computer by running a program from a computer readable medium, including but not limited to storage media such as magnetic storage media (e.g., ROM's, floppy disks, hard disks, etc.), optically readable media (e.g., CD-ROMs, DVDs, etc.) and carrier waves (e.g., transmissions over the internet), The present invention may be embodied as a computer readable medium with a computer readable program code unit embodied therein for causing a number of computer systems connected via a network to affect distributed processing.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of controlling display of a program guide, comprising:
displaying a lock setting menu and requesting a password if a lock mode command for a channel is issued;
locking a corresponding channel if a password input by a user is identical to a predetermined password; and
skipping program information of the locked channel and collecting program information of non-locked channels for display on a screen if a program guide signal for all channels is received.

2. The method of claim 1, further comprising,
creating a program guide using the program information of the non-locked channels.

3. The method of claim 1, further comprising:
requesting a password if a lock mode for a program is detected while displaying the program guide;
selecting and locking at least one among all programs of a corresponding channel in the program guide if a password input by a user is identical to a predetermined password; and
outputting on a screen a viewer warning message for a locked program at a beginning broadcasting time for the locked program of the corresponding channel, and outputting a non-locked program on the screen.

4. An apparatus which controls the display of a program guide, in a digital television receiver, the apparatus comprising:
a signal processor which extracts program guide information included in a broadcast signal; and
a controller which locks a corresponding channel if a lock mode command is issued and skips program information of the locked channel among the program guide information extracted by the signal processor.

5. The apparatus of claim 4, wherein the controller further collects program information for non-locked channels to create a program guide.

6. The apparatus of claim 4, wherein the controller further creates a program guide using the program information of the non-locked channels.

7. A computer readable medium of instructions adapted for controlling a device to display a program guide, comprising:
a first set of instructions adapted to control the device to display a lock setting menu and request a password if a lock mode command for a channel is issued;
a second set of instructions adapted to control the device to lock a corresponding channel if a password input by a user is identical to a predetermined password; and
a third set of instructions adapted to control the device to skip program information of the locked channel and collect program information of non-locked channels for display on a screen if a program guide signal for all channels is received.

8. The computer readable medium of instructions of claim 7, further comprising,
a fourth set of instructions adapted to control the device to create a program guide using the program information of the non-locked channels.

9. The computer readable medium of instructions of claim 7, further comprising:
a fifth set of instructions adapted to control the device to request a password if a lock mode for a program is detected while displaying the program guide; select and lock at least one among all programs of a corresponding channel in the program guide if a password input by a user is identical to a predetermined password; and output on a screen a viewer warning message for a locked program at a beginning broadcasting time for the locked program of the corresponding channel, and output a non-locked program on the screen.
